(19) United States
(12) Patent Application Publication
(10) Pub. No.: US 2004/0230446 A1
(43) Pub. Date: Nov. 18, 2004

(54) Method and system of automatically registering domain name

(75) Inventors: Soo-Hong Park, Yongin-si (KR); Young-Keun Kim, Maetropolitan-city (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/748,169

(22) Filed: Dec. 31, 2003

(30) Foreign Application Priority Data
May 13, 2003 (KR) 2003-30365

(51) Int. Cl. G06F 17/60

(52) U.S. Cl. 705/1

(57) ABSTRACT

A method and a system of automatically creating and registering a domain name and an IP address in an IPv6 (IP version 6) network are provided. According to the method of automatically registering a domain name, name information of a network including a host is received. A link local address of the host is created and it is determined whether the created link local address has already been used. If the created link local address has not been used, an interface ID used to determine the host is extracted from the created link local address. A domain name is created using the extracted interface ID and the received name information of the network. The created domain name is registered in a domain name server.

### CROSS REFERENCE TO RELATED APPLICATION

This application claims the priority of Korean Patent Application No. 2003-30365, filed on May 13, 2003, in the Korean Intellectual Property Office, the disclosure of which is hereby incorporated by reference in its entirety.

### BACKGROUND OF THE INVENTION

1. Field of the Invention

The present invention relates to management of a domain name and an IP address for domain name service (DNS), and more particularly, to a method and a system of automatically creating and registering a domain name and an EP address in an IPv6 (IP version 6) network.

2. Description of the Related Art

To connect a host to a network, a domain name and an IP address of the host must be registered in a domain name server.

FIG. 1 illustrates a host and a domain name server in an IP network.

A host 110 in the IP network has a domain name and an IP address. For example, if the name of the host 110, located in a network domain of Samsung Electronics. Co. Ltd., is “daniel”, the domain name of the host 110 is “daniel.samsung.com”. Also, an IP address is assigned to each domain name. The IP address is assigned by a network manager. Here, in order to explain an IPv6 (IP version 6) network as the IP network, it is assumed that the IP address of the host 110 is 2001::1.

In a domain name server 120, the domain name “daniel.samsung.com” and the IP address “2001::1” corresponding to the domain name are mapped and stored. The domain name “daniel.samsung.com” and the IP address “2001::1” are manually registered in the domain name server 120 by a network manager.

Thus, when the network manager has little experience with and little knowledge of network configuration and setting, it is difficult to register the domain name and the IP address of the host in the domain name server. Moreover, any error in the network setting of the network manager may interrupt the operation of the whole network.

### SUMMARY OF THE INVENTION

The present invention provides a method and a system of automatically creating and registering a domain name and an IP address of a host in an IP network.

According to one aspect of the present invention, there is provided a method of automatically registering a domain name. The method comprises (a) receiving name information of a network including a host, (b) creating a link local address of the host and determining whether the created link local address has already been used, (c) if the created link local address has not been used, extracting an interface ID used to determine the host from the created link local address, (d) creating a domain name using the extracted interface ID and the received name information of the network, and (e) registering the created domain name in a domain name server.

The method can further include (f) receiving the created domain name through a message and (g) if the created domain name is already present in the domain name server, notifying the host of the presence of the created domain name to create a new domain name.

In step (f), the created domain name is received through a neighbor solicitation (NS) message.

In step (g), if the created domain name is already present in the domain name server, presence of the created domain name is recorded to a neighbor advertisement (NA) message, the NA message is transmitted to the host to control the host to create a new domain name.

The name information of the network corresponds to a suffix of the network including the host.

In step (d), “interface ID.suffix” is created as the domain name.

In step (a), the name information of the network is received through a router advertisement (RA) message.

In step (b), it is determined whether the created link local address has already been used using duplicate address detection (DAD).

In step (c), the lower 64 bits of the created link local address, except for its prefix, are extracted as the interface ID.

The host is an IPv6 host.

According to another aspect of the present invention, there is provided a system of automatically registering a domain name. The system comprises a host and an auto-registration server. The host receives name information of a network, creating a domain name, and outputting the created domain name. The auto-registration server transmits the name information of the network to the host, receives the created domain name, and registers the created domain name in a domain name server.

The host comprises a link local address creating unit, an interface ID extracting unit, and a domain name creating unit. The link local address creating unit creates a link local address. The interface ID extracting unit receives the created link local address and extracts an interface ID from the received link local address. The domain name creating unit creates a domain name using the extracted interface ID.

The link local address creating unit creates a link local address, determines whether the created link local address is already present in the domain name server using duplicate address detection (DAD), and if the created link local address is already present in the domain name server, creates a new link local address.

The interface ID extracting unit extracts the lower 64 bits of the created link local address, except for its prefix, as an interface ID.

The auto-registration server comprises a network name information transmitting unit, a domain name managing unit, and a domain name information storing unit. The network name information transmitting unit transmits name information of a network to the host. The domain name managing unit receives the domain name, registers the received domain name in a domain name server, and if the received domain name is already present in the domain name server, notifies the host of the presence of the received domain name. The domain name information storing unit stores the registered domain name information a predetermined amount of time.

The network name information transmitting unit transmits the name information of the network through a router advertisement (RA) message.

The domain name managing unit receives the created domain name through a neighbor solicitation (NS) message and if the received domain name is already present in the domain name server, records the presence of the received domain name to a neighbor advertisement (NA) message, and transmits the NA message to the host to control the host to create a new domain name.

The host is an IPv6 host.

According to yet another aspect of the present invention, there is provided a computer readable recording medium having embodied thereon a method of automatically registering a domain name, wherein the method comprises (a) receiving name information of a network including a host, (b) creating a link local address of the host and determining whether the created link local address has already been used, (c) if the created link local address has not been used, extracting an interface ID used to determine the host from the created link local address, (d) creating a domain name using the extracted interface ID and the received name information of the network, and (e) registering the created domain name in a domain name server.

### BRIEF DESCRIPTION OF THE DRAWINGS

The above and other aspects and advantages of the present invention will become more apparent by describing in detail an exemplary embodiment thereof with reference to the attached drawings in which:

FIG. 1 illustrates a host and a domain name in an IP network;

FIG. 2 is a view for explaining a method of automatically creating and registering a domain name and an IP address in an IP network, according to the present invention;

FIG. 3 illustrates a neighbor solicitation (NS) message format;

FIG. 4 illustrates a router advertisement (RA) message format;

FIG. 5 illustrates a neighbor advertisement (NA) message format; and

FIG. 6 is a flowchart describing a method of registering a domain name according to the present invention.

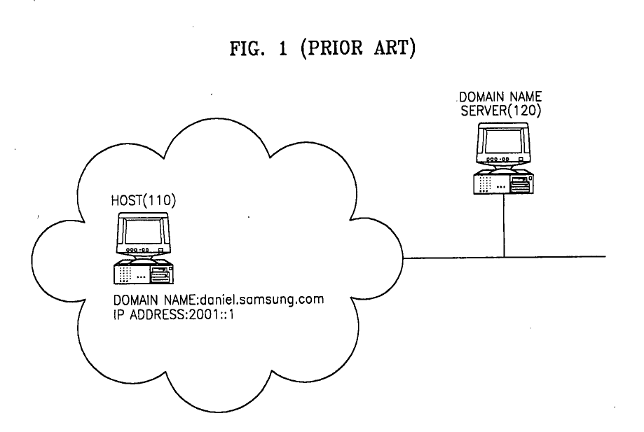

### DETAILED DESCRIPTION OF THE INVENTION

The present invention will now be described more fully with reference to the accompanying drawings, in which a preferred embodiment of the invention is shown.

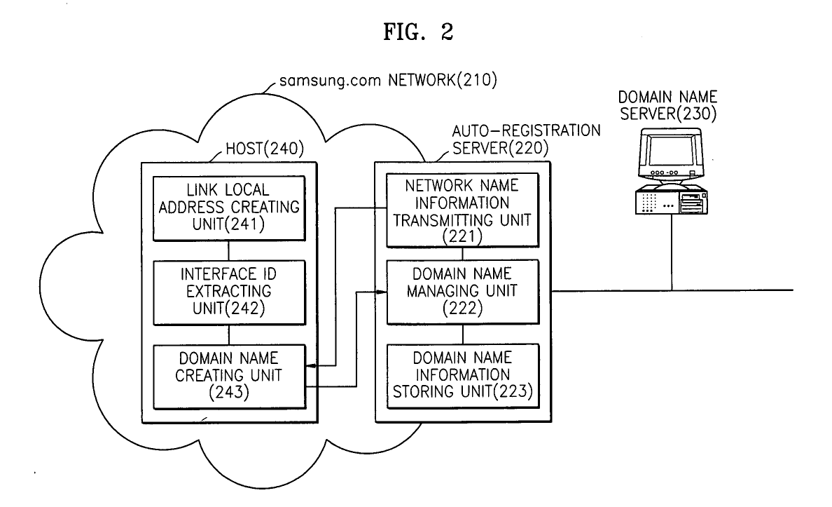

FIG. 2 is a view for explaining a method of automatically creating and registering a domain name and an IP address in an IP network, according to the present invention.

If the name of a network 210 is “samsung.com”, there can be several IPv6 hosts in the network 210. Each IPv6 host creates its own domain name and registers the created domain name in a domain name server 230 through an auto-registration server 220.

A host 240 creates its own link local address, i.e., an IPv6 address used only in a local network. Then, the host 240 determines whether the created link local address has already been used. The determination of the host 240 can be performed using duplicate address detection (DAD). If the created link local address has not been used, a domain name is created using an interface ID and a network suffix. The interface ID is created in accordance with IEEE EUI64 and corresponds to the lower 64 bits of the created link local address of 128 bits.

The host 240 includes a link local address creating unit 241, an interface ID extracting unit 242, and a domain name creating unit 243. The link local address creating unit 241 creates a link local address. The interface ID extracting unit 242 receives the link local address and extracts an interface ID from the link local address. The domain name creating unit 243 creates a domain name using the interface ID. Hereinafter, creation of the domain name will be described with examples.

For example, if a suffix is “samsung.com”, a domain name is “interface ID.samsung.com”. The suffix is received from the auto-registration server 220. The created domain name is recorded to an OPTION field of a neighbor solicitation (NS) message and transmitted to the auto-registration server 220. Since the interface ID is composed of numbers of 64 bits, it is difficult to memorize and use the interface ID. Thus, a name that corresponds to the interface ID and can be conveniently used can be previously stored, and the name instead of a determined interface ID can be used to create a domain name.

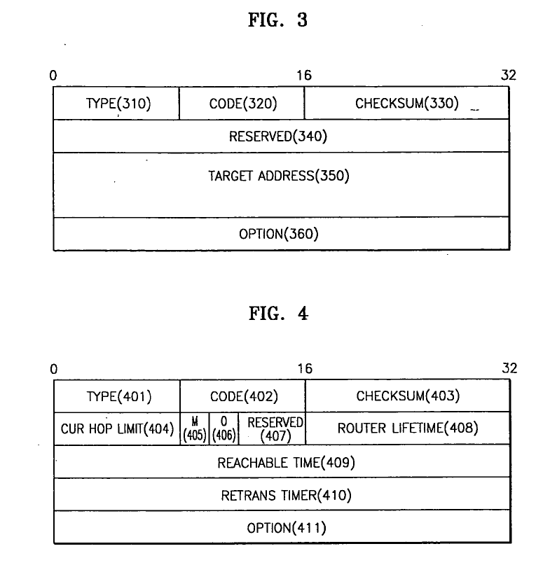

FIG. 3 illustrates an NS message format.

The NS message includes a type field 310, a code field 320, a checksum field 330, a reserved field 340, a target address field 350, and an option field 360. A domain name created by a host is recorded to the option field 360 of the NS message.

The auto-registration server 220 includes a network name information transmitting unit 221, a domain name managing unit 222, and a domain name information storing unit 223.

The network name information transmitting unit 221 transmits name information of the network 210 to the host 240. The network name is used as a suffix and, in the present invention, corresponds to “samsung.com”. Here, suffix information is recorded to the option field 411 of a router advertisement (RA) message and transmitted to the host 240. The suffix may change, and thus, if the suffix changes, the changed suffix is transmitted to the host 240. The domain name managing unit 222 registers a domain name and an IP address, which are created by the host 240 using a dynamic update protocol, in the domain name server 230.

In other words, the domain name managing unit 222 receives a domain name “interface ID.samsung.com”, registers the domain name in the domain name server 230, and if the received domain name is already present in the domain name server 230, notifies the host 240 of the presence of the domain name using the NS message. The domain name information storing unit 223 stores the registered domain name information for a predetermined amount of time. If an IP address to which the domain name is to be registered has already been used, the domain name information storing unit 223 notifies the host 240 of the fact in order to control the host 240 to create a new domain name.

FIG. 4 illustrates an RA message format.

The RA message includes a type field 401, a code field 402, a checksum field 403, a CUR HOP LIMIT field 404, an M field 405, an O field 406, a reserved field 407, a router lifetime field 408, a reachable time field 409, a retrans timer field 410, and an option field 411. The suffix information is recorded to the option field 411 of the RA message and transmitted to the host 240.

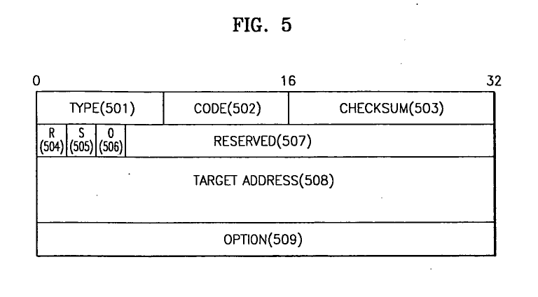

FIG. 5 illustrates a neighbor advertisement (NA) message format.

The NA message includes a type field 501, a code field 502, a checksum field 503, an R field 504, an S field 505, an O field 506, a reserved field 507, a target address field 508, and an option field 509. If an IP address to which the domain name is to be registered has already been used, this information is recorded to the option field 509 of the NA message, and the NA message is transmitted to the host 240 in order to control the host 240 to create a new domain name.

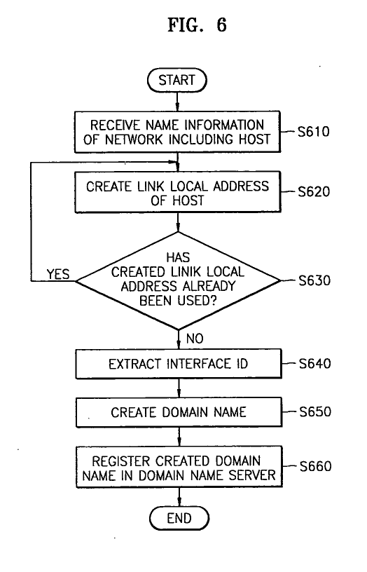

FIG. 6 is a flowchart describing a method of registering a domain name according to the present invention.

Referring to FIG. 6, a domain name is registered as follows. First, name information of a network including a host is received (step S610). Then, a link local address of the host is created (step S620). It is determined whether the created link local address has already been used (step S630). If the created link local address has not been used, an interface ID, which is used to determine the host, is extracted from the created link local address (step S640). A domain name is created using the extracted interface ID and the received name information of the network (step S650). Then, the created domain name is registered in a domain name server (step S660).

The present invention may be embodied as a computer readable code in a computer readable recording medium. The computer readable recording medium may be a recording device in which data that is readable by a computer system is stored. The computer readable recording medium includes but is not limited to ROM, RAM, CD-ROM, magnetic tapes, hard disks, floppy disks, flash memory, optical data storage media, and carrier waves (e.g., transmissions over the Internet). In addition, the computer readable recording medium may be distributed over the computer system connected via a network, and stored and implemented as a computer readable code using a distribution technique.

As described above, according to a method and a system of automatically creating and registering a domain name and an IP address, a host connected to a network automatically creates and registers a domain name. Thus, it is possible for a common user having little knowledge of a network to easily establish a network environment in a home network.

In addition, when a plurality of IPv6 hosts is present, a domain name can be automatically assigned to the IPv6 hosts without overlap between domain names. In other words, since the domain name is created using a non-overlapping interface ID, overlap between domain names does not occur.

While the present invention has been particularly shown and described with reference to an exemplary embodiment thereof, it will be understood by those of ordinary skill in the art that various changes in form and details may be made therein without departing from the spirit and scope of the invention as defined by the appended claims and their equivalents.

What is claimed is:

1. A method of automatically registering a domain name, the method comprising:
(a) receiving name information of a network having a host;
(b) creating a link local address of the host and determining whether the created link local address has already been used;
(c) if the created link local address has not been used, extracting an interface ID used to determine the host, from the created link local address;
(d) creating a domain name using the extracted interface ID and the received name information of the network; and
(e) registering the created domain name in a domain name server.

2. The method of claim 1, further comprising:
(f) receiving the created domain name through a message; and
(g) if the created domain name is already present in the domain name server, notifying the host of a presence of the created domain name so that a new domain name is created.

3. The method of claim 2, wherein in step (f), the created domain name is received through a neighbor solicitation (NS) message.

4. The method of claim 2, wherein in step (g), if the created domain name is already present in the domain name server, the presence of the created domain name is recorded to a neighbor advertisement (NA) message, and the NA message is transmitted to the host to control the host to create a new domain name.

5. The method of claim 1, wherein the name information of the network corresponds to a suffix of the domain name of the network having the host.

6. The method of claim 5, wherein in step (d), “interface ID.suffix” is created as the domain name, wherein “interface ID” corresponds to the extracted interface ID.

7. The method of claim 1, wherein in step (a), the name information of the network is received through a router advertisement (RA) message.

8. The method of claim 1, wherein in step (b), it is determined whether the created link local address has already been used using duplicate address detection (DAD).

9. The method of claim 1, wherein in step (c), a lower 64 bits of the created link local address, except for its prefix, is extracted as the interface ID.

10. The method of claim 1, wherein the host is an IPv6 host.

11. A system of automatically registering a domain name, the system comprising:
a host, which receives name information of a network, creates a domain name, and outputs the created domain name; and
an auto-registration server, which transmits the name information of the network to the host, receives the created domain name, and registers the created domain name in a domain name server.

12. The system of claim 11, wherein the host comprises:
a link local address creating unit, which creates a link local address;
an interface ID extracting unit, which receives the created link local address and extracts an interface ID from the received link local address; and
a domain name creating unit, which creates a domain name using the extracted interface ID.

13. The system of claim 12, wherein the link local address creating unit creates the link local address, determines whether the created link local address is already present in the domain name server using duplicate address detection (DAD), and if the created link local address is already present in the domain name server, creates a new link local address.

14. The system of claim 12, wherein the interface ID extracting unit extracts the lower 64 bits of the created link local address, except for a prefix, as the interface ID.

15. The system of claim 11, wherein the auto-registration server comprises:
a network name information transmitting unit, which transmits the name information of the network to the host;
a domain name managing unit, which receives the domain name, registers the received domain name in a domain name server, and if the received domain name is already present in the domain name server, notifies the host that the received domain name is already present in the domain name server; and
a domain name information storing unit, which stores the registered domain name information a predetermined amount of time.

16. The system of claim 15, wherein the network name information transmitting unit transmits the name information related to the network through a router advertisement (RA) message.

17. The system of claim 15, wherein the domain name managing unit receives the created domain name through a neighbor solicitation (NS) message and if the received domain name is already present in the domain name server, records the presence of the received domain name to a neighbor advertisement (NA) message, transmits the NA message to the host in order to control the host to create a new domain name.

18. The system of claim 11, wherein the host is an IPv6 host.

19. A computer readable recording medium having embodied thereon a method of automatically registering a domain name, wherein the method comprises:
(a) receiving name information of a network having a host;
(b) creating a link local address of the host and determining whether the created link local address has already been used;
(c) if the created link local address has not been used, extracting an interface 1D used to determine the host from the created link local address;
(d) creating a domain name using the extracted interface ID and the received name information of the network; and
(e) registering the created domain name in a domain name server.
